(19) United States
(12) Patent Application Publication
(10) Pub. No.: US 2019/0336371 A1
(43) Pub. Date: Nov. 7, 2019

(54) INFLATABLE MATTRESS

(71) Applicant: Khalil Mahmoud Abu Al-Rubb, London (GB)

(72) Inventor: Khalil Mahmoud Abu Al-Rubb, London (GB)

(21) Appl. No.: 16/466,441

(22) PCT Filed: Dec. 5, 2017
(86) PCT No.: PCT/EP2017/081555

§ 371 Date: Jun. 4, 2019

(30) Foreign Application Priority Data
Dec. 6, 2016 (LU) LU-93336

(51) Int. Cl. A61G 7/057; A47C 27/10; A47C 27/08; A47C 27/00

(52) U.S. Cl. CPC A61G 7/05776; A47C 27/10; A47C 27/002; A61G 7/05784; A47C 27/083

(57) ABSTRACT

An inflatable mattress comprising a number of longitudinal compartments, each of which is independently inflatable. A method of changing a sheet or other bedding by sequentially inflating and deflating longitudinal compartments of a mattress.

### TECHNICAL FIELD

This invention relates to an inflatable mattress and, in particular, an inflatable mattress having a plurality of compartments, to a bedding arrangement comprising such inflatable mattress and to a method of changing a sheet on an inflatable mattress.

### BACKGROUND

For invalids a major cause of complications arises from extended bed rest. Infections from bed sores and soiled bedding can contribute to the severity of these complications. It is difficult to change bedding where the patient is immobile. Currently, this is done by rolling the patient from side to side while the bedding changed, or if the patient cannot be moved, by lifting the patient up using a crane or other mechanical assistance.

Moving the patient is uncomfortable and may exacerbate any discomfort the patient is experiencing. Mechanical assistance such as a crane is expensive and logistically difficult. In other cases where patients have broken bones or hip replacement movement might be forbidden for extended periods. For these reasons it is desirable to provide a new bedding arrangement to cure the above-mentioned disadvantages while preventing infections from soiled bedding and bedsores.

To this end, U.S. Pat. No. 3,653,083 (Lapidus) discloses an aerated bed pad which comprises a flexible, resilient, porous sheet supported by a pad-like structure including means for passing a current of air at the interface between the user and the porous pad resulting in a flexible and comfortable support which prevents skin rashes and bedsores.

US Patent Application Publication No 2002/0073489 (Totton) discloses an air inflatable mattress and mattress coverlet which incorporates a user selectable static or alternating air powered support surface for more uniformly redistributing pressure exerted on a patient's skin and so preventing and treating decubitus ulcers (i.e., pressure sores or bedsores).

U.S. Pat. No. 5,926,884 (Biggie) discloses an air distribution device with a plurality of sheets from which air escapes for removing excess moisture from the patient's skin and wound, and so preventing and treating decubitus ulcers.

### SUMMARY

According to a first aspect of the invention, there is provided an inflatable mattress, this inflatable mattress comprising a plurality of longitudinal compartments, wherein each compartment is independently inflatable from the other compartments and extends from a first side or edge of the mattress to a second side or edge of the mattress. Typically, the first side or edge and the second side or edge may be different.

The first side or edge and the second side or edge may be located opposite one another. The first side or edge may be a top side or edge of the mattress, and the second side or edge may be a bottom side or edge of the mattress, or vice versa. The first side or edge may be a left side or edge of the mattress, and the second side or edge may be a right side or edge of the mattress, or vice versa.

The first side or edge and the second side or edge may be located adjacent one another. The first side or edge may be a top side or edge or a bottom side or edge of the mattress, and the second side or edge may be a left side or a right side of the mattress, or vice versa.

Typically, the mattress may be quadrilateral in shape, e.g. may be substantially rectangular or square.

Each compartment of the mattress may extend obliquely from a first side or edge of the mattress to a second side or edge of the mattress, and/or between adjacent sides or edges of the mattress.

Each compartment of the mattress may extend longitudinally along a length or width of the mattress, and/or between opposite sides or edges of the mattress.

Each compartment of the mattress may extend along an entire dimension of the mattress, e.g., along a/the entire length of the mattress or across a/the entire width of the mattress.

The term “plurality” of compartments will be herein understood to mean two or more compartments or at least two compartments.

The term “independently” will be herein understood as meaning independent from each other or independent from all other. One or more compartment(s) may be inflated independently to one or more other compartment(s). Similarly, one or more compartment(s) may be deflated independently to one or more other compartment(s). One compartment may be inflated and another compartment may be deflated, such compartments being adjacent or not. The inflation or deflation of one compartment will not affect the inflated state of any of the other compartments.

The inflatable mattress may comprise two or more horizontal compartments and each horizontal component may extend along an entire width of the mattress or along an entire length of the mattress.

Each compartment of the inflatable mattress may have a corresponding valve and each valve may be connected to a source of compressed fluid. This source of compressed fluid may be connected to a control unit and the control unit may be configured to selectively inflate and deflate said compartments. The control unit may be adapted to inflate and/or deflate said compartments according to a predetermined sequence.

The inflatable mattress may comprise means for ventilating an occupant of the mattress and the ventilation means may comprise a plurality of perforated hoses disposed in furrows formed by adjacent compartments.

The present invention relates also to a bedding arrangement comprising an inflatable mattress according to the invention and a rollable sheet.

This bedding arrangement may comprises an inflatable mattress wherein each compartment has a corresponding valve connected to a source of compressed fluid and wherein the source of the compressed fluid is connected to a control unit and wherein the control unit is configured and adapted to selectively inflate and deflate said compartments according to a predetermined sequence, said sequence allowing said rollable sheet to be rolled between a top of the mattress and an occupant of the bed.

The mattress can be arranged on a bed and may extend longitudinally over the bed, e.g. over a/the entire surface of the bed e.g, along a/the entire length and/or a/the entire width of the bed. Each compartment of the mattress may extend from the top of the bed to the bottom of the bed or from one side or edge of the bed to another, e.g. an opposite side or edge of the bed, horizontally relative to the bed.

According to a second aspect of the invention, there is provided a method of changing a sheet on an inflatable mattress, said mattress being occupied by an occupant and comprising a plurality of separately inflatable compartments, said method comprising the steps of:

deflating a first set of one or more of said compartments to form a void between said occupant and the bed;

inserting a sheet into said void;

deflating a second set of compartment to increase a size of the void;

moving the sheet in the void; and

inflating the first set of compartments.

This method of changing a sheet on an inflatable mattress may further comprise repeating steps of inflating and deflating subsequent sets of compartments, and moving the sheet in the void.

In this method according to the present invention, the inflation and deflation of each compartment may be controlled by a corresponding valve and each valve may be connected to a source of compressed fluid, said method comprising the step of controlling the source of compressed fluid to inflate and deflate the compartments. The features described above in respect of the first aspect of the invention may equally apply to the method according to the second aspect of the invention, and are therefore not repeated here, merely for reasons of brevity.

### DESCRIPTION OF ACCOMPANYING FIGURES

FIG. 1 illustrates an inflatable mattress according to a preferred embodiment of the invention;

FIG. 2 illustrates a process of changing a sheet on an inflatable mattress according to an embodiment of the invention; and

FIG. 3 illustrates an inflatable mattress according to a preferred embodiment of the invention.

### DESCRIPTION OF EMBODIMENTS

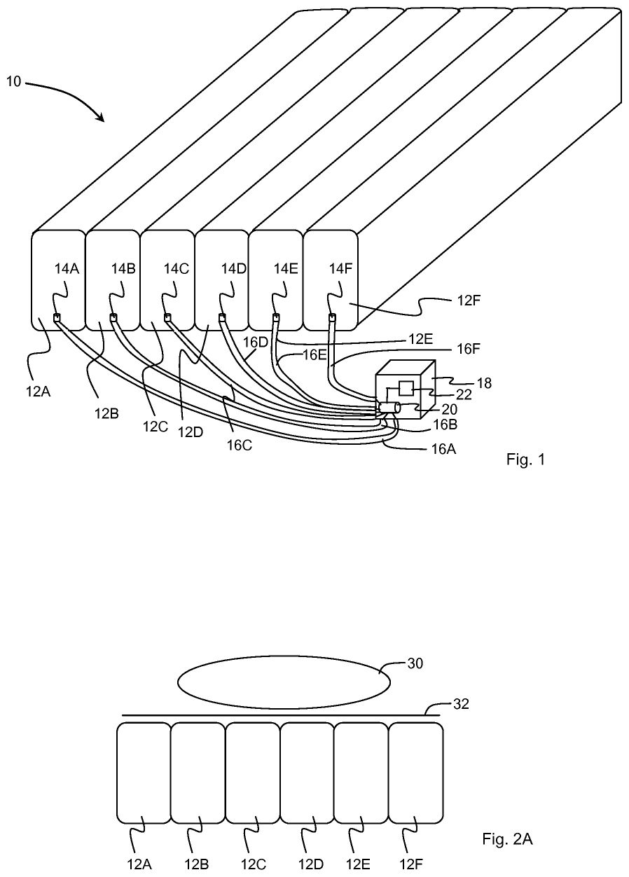

FIG. 1 illustrates an inflatable mattress 10 according to an embodiment of the invention. The mattress 10 comprises a plurality of inflatable compartments 12A, 12B, 12C . . . 12F. In the embodiment illustrated there are six compartments 12A, 12B, 12C, 12D, 12E and 12F. However, it is to be realised that any number of compartments could be used, and will generally depend on the size of the mattress to lay for example on a bed. Embodiments of the invention may therefore be used with varying sizes of mattress which can be used for different sizes of bed.

Each of the compartments 12A . . . 12F are rectangular compartments in that they are orientated parallel to a length of the mattress 10. However, it is to be realised that embodiments of the invention also extend to a square mattress. In an alternative design the compartments can be horizontal along the width of the mattress too. Other shapes are also possible but might require more connections and more complex inflation and deflation system. In embodiments, the compartments extend over the entire length of an occupancy area.

Each of the compartments has a corresponding valve 14A, 14B, 14C . . . 14F connected to an inflator 18 by corresponding hoses 16A, 16B, 16C . . . 16F. The hoses are connected to a source of compressed air, in this embodiment, a compressor 20. The compressor 20 is controlled by a control unit 22.

In this embodiment, the hoses 16A . . . 16F also carry electrical signals between the control unit 22 and the valves 14A . . . 14F. Therefore, the control unit 22 is able to control the opening and closing of the valves and, by controlling the compressor 20, is able to selectively inflate or deflate each of the compartments 12A . . . 12F. Importantly for embodiments of the invention, the compartments are independently inflatable and deflatable, i.e. the inflation or deflation of one compartment will not affect the inflated state of any of the other compartments.

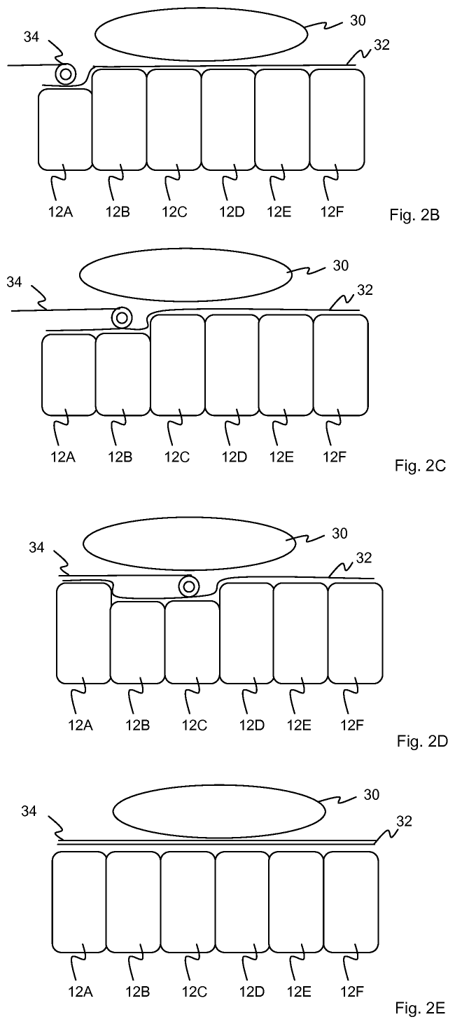

FIGS. 2A to 2E illustrate a process of changing a sheet on the mattress 10. For the sake of clarity, only the compartments 12A . . . 12F are shown. The remaining elements of the mattress have been omitted.

FIG. 2A illustrates an occupant 30 of the mattress 10 and a mattress sheet 32 disposed between the occupant 30 and the mattress 10. FIG. 2B illustrates a clean sheet 34 provided in a rolled form which is introduced over the dirty sheet 32. To accommodate the roll of the clean sheet 34, the first compartment 12A is partially deflated and the roll introduced into the void formed by the deflated compartment.

The next step illustrated in FIG. 2C, the following compartment, compartment 12B is deflated and the clean sheet 34 rolled into the void formed thereby.

As illustrated in FIG. 2D, in the next step compartment 12C is deflated and the clean sheet 34 rolled into the void formed thereby. At the same time, compartment 12A is re-inflated. The inflated compartments 12A, 12D etc. will support the occupant 30.

The roller from which the new sheet is rolled should have sufficient weight to ensure that the compartments depressed sufficiently. Alternatively, mechanical means may be used to roll the roller across each compartment from end to end.

The process is repeated by deflating subsequent compartments and inflating previously deflated compartments so that the void under the occupant 30 moves below the occupant 30 and, at the same time, the new sheet 34 is unrolled to occupy the void. Although the representation of figures is schematic, it is to be realised that the size of the compartments will determine the amount of support provided to the occupant during the process. Therefore, the compartments may be sized to ensure that the occupant feels little or no discomfort during the process.

FIG. 2E illustrates the arrangement once the process of unrolling the clean sheet 34 has completed. As illustrated, the clean sheet 34 is then disposed on top of the old sheet 32 and beneath the occupant 30. The old sheet may then be moved by gently lifting occupant using the new sheet 34, as illustrated in FIG. 2F.

The rolling procedure of new mattress sheets can be done manually or automatically.

The same rolling procedure of new mattress sheets may also be applied to remove the old sheet beneath the occupant 30 instead of gently lifting occupant if the occupant cannot be moved at all.

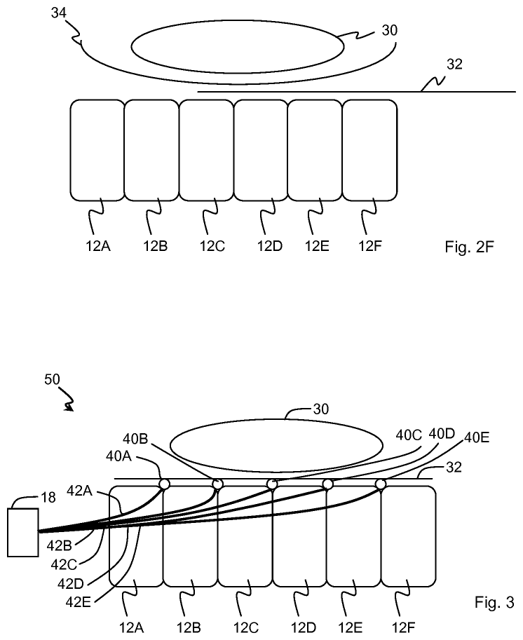

FIG. 3 illustrates an inflatable mattress 50 according to a further preferred embodiment of the invention. The inflatable mattress 50 is similar to the mattress 10 and similar reference numbers have been used to refer to similar components.

The mattress 50 includes five hoses 40A, 40B, 40C, 40D and 40E which extend lengthways along the bed. The hoses are connected by corresponding connecting hoses 42A, 42B, 42C, 42 D and 42E to the inflator 18. The hoses 40A, . . . , 40E are perforated and when the inflator 18 provides air to them, this causes ventilation for the occupant of the bed. This helps to reduce the accumulation of sweat in the channels between adjacent compartments as well as general cooling of the patient body that is in touch with the mattress surface that is prone to sweating in general.

In a further embodiment, the inflatable mattress may include a layer of memory foam or other open cell structured material to assist in the air flow between the occupant of the mattress and the mattress itself.

1. An inflatable mattress comprising a plurality of longitudinal compartments, wherein each compartment is independently inflatable from the other compartments and extends from a first side or edge of the mattress to a second side or edge of the mattress

2. The inflatable mattress according to claim 1, wherein each compartment extends along an entire length or width of the mattress.

3. The inflatable mattress according to claim 1, comprising two or more horizontal compartments.

4. The inflatable mattress according to claim 1, wherein each compartment has a corresponding valve.

5. The inflatable mattress according to claim 4, wherein each valve is connected to a source of compressed fluid.

6. The inflatable mattress according to claim 5, wherein the source of compressed fluid is connected to a control unit and wherein the control unit is configured to selectively inflate and deflate said compartments.

7. The inflatable mattress according to claim 6, wherein the control unit is adapted to inflate and deflate said compartments according to a predetermined sequence.

8. The inflatable mattress according to claim 1, comprising means for ventilating an occupant of the mattress.

9. The inflatable mattress according to claim 8, wherein the ventilation means comprises a plurality of perforated hoses disposed in furrows formed by adjacent compartments.

10. The inflatable mattress according to claim 1, further comprising a bedding arrangement comprising the inflatable mattress and a rollable sheet.

11. The bedding arrangement according to claim 7, further comprising a bedding arrangement comprising the inflatable mattress and a rollable sheet wherein said sequence allows said rollable sheet to be rolled between a top of the mattress and an occupant of the bed.

12. A method of changing a sheet on an inflatable mattress, said mattress being occupied by an occupant and comprising a plurality of separately inflatable compartments, said method comprising:
deflating a first set of one or more of said compartments to form a void between said occupant and the bed;
inserting a sheet into said void;
deflating a second set of compartment to increase a size of the void;
moving the sheet in the void; and
inflating the first set of compartments.

13. The method according to claim 12, further comprising repeating steps of inflating and deflating subsequent sets of compartments, and moving the sheet in the void.

14. The method according to claim 12, wherein inflation and deflation of each compartment is controlled by a corresponding valve.

15. The method according to claim 14, wherein each valve is connected to a source of compressed fluid, said method comprising the step of controlling the source of compressed fluid to inflate and deflate the compartments.
